(19) United States
(12) Patent Application Publication
(10) Pub. No.: US 2024/0346598 A1
(43) Pub. Date: Oct. 17, 2024

(54) EQUITY CONVERSION AND TRACKING SYSTEMS

(71) Applicant: Jeremy Aren Badillo, Marietta, GA (US)

(72) Inventor: Jeremy Aren Badillo, Marietta, GA (US)

(21) Appl. No.: 18/628,725

(22) Filed: Apr. 6, 2024

Related U.S. Application Data
(60) Provisional application No. 63/458,835, filed on Apr. 12, 2023.

(51) Int. Cl. G06Q 40/06

(52) U.S. Cl. CPC G06Q 40/06

(57) ABSTRACT

A method of assessing and tracking equity in an asset for a consumer includes gathering data for the consumer, gathering data for the asset, gathering geographic data, defining a consumer cohort, analyzing data, and outputting recommendations for improving the consumer cohort. The data analysis includes consumer, asset, and geographic data.

### CROSS REFERENCE TO RELATED APPLICATION

This application is related to and claims priority benefit from U.S. Provisional Application No. 63/458,835 (“the '835 application”), filed on Apr. 12, 2023. The '835 application is hereby incorporated in its entirety by this reference.

### FIELD OF THE INVENTION

The field of the invention relates to methods and software for predicting asset value, particularly equity at given points in time to maximize a resale value and optimize equity gains.

### BACKGROUND

Many consumers finance large purchases (including automobiles, trucks, boats, recreational vehicles, airplanes, motorcycles, trailers, etc.) for personal and/or business use. However, many of these items lose value and/or depreciate during the life of the loan. Conventional loan practices and software for tracking loan information favor the seller and the financial institution(s) without collecting and considering sufficient data related to the value of the item or providing sufficient information relevant to the consumer.

To allow a consumer to better understand the current value of a financed item in real time based on various factors and be able to reliably predict future values of the financed item, it may be desirable to design new software systems that allow a consumer to maximize the value of the financed item leading to better financial outcomes and increased sales activity.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a method of assessing and tracking equity in an asset for a consumer comprises: gathering data for the consumer; gathering data for the asset; gathering geographic data; defining a consumer cohort; analyzing consumer, asset, and geographic data; and outputting recommendations for improving the consumer cohort.

### BRIEF DESCRIPTION OF THE DRAWINGS

FIG. 1 is a component-level diagram of some embodiments of an equity tracking system according to certain embodiments of the present invention.

FIG. 2 is a flowchart for initial steps for the equity tracking system of FIG. 1.

FIG. 3 is a flowchart for a registered consumer for the equity tracking system of FIG. 1.

FIG. 4A is a predicted depreciation chart for an asset of the equity tracking system of FIG. 1.

FIG. 4B is a predicted total cost after selling the asset of FIG. 4A.

FIG. 4C is an amortized monthly cost during the finance term of the asset of FIG. 4A.

FIG. 5A is a predicted depreciation chart for an asset of the equity tracking system of FIG. 1.

FIG. 5B is a predicted total cost after selling the asset of FIG. 5A.

FIG. 5C is an amortized monthly cost during the finance term of the asset of FIG. 5A.

FIG. 6A is a predicted depreciation chart for an asset of the equity tracking system of FIG. 1.

FIG. 6B is a predicted total cost after selling the asset of FIG. 6A.

FIG. 6C is an amortized monthly cost during the finance term of the asset of FIG. 6A.

FIG. 7A is a predicted depreciation chart for an asset of the equity tracking system of FIG. 1.

FIG. 7B is a predicted total cost after selling the asset of FIG. 7A.

FIG. 7C is an amortized monthly cost during the finance term of the asset of FIG. 7A.

FIG. 8A is a predicted depreciation chart for an asset of the equity tracking system of FIG. 1.

FIG. 8B is a predicted total cost after selling the asset of FIG. 8A.

FIG. 8C is an amortized monthly cost during the finance term of the asset of FIG. 8A.

FIG. 9A is a predicted depreciation chart for an asset of the equity tracking system of FIG. 1.

FIG. 9B is a predicted total cost after selling the asset of FIG. 9A.

FIG. 9C is an amortized monthly cost during the finance term of the asset of FIG. 9A.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

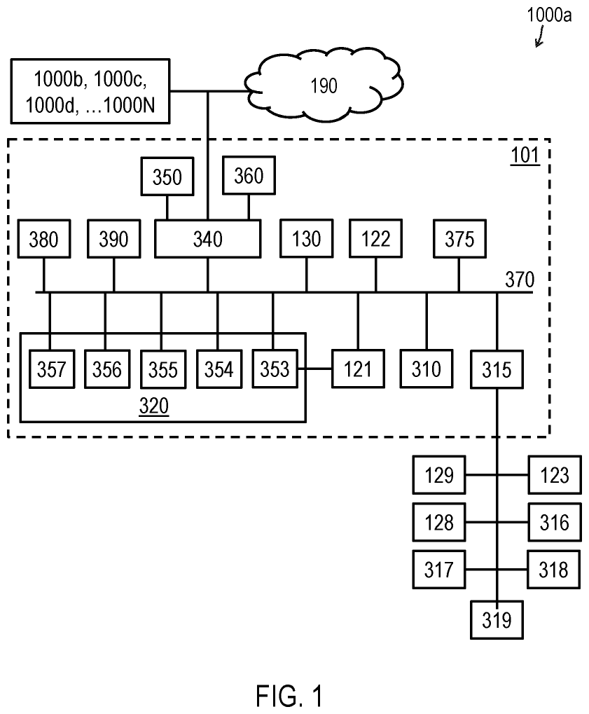

According to certain embodiments of the present invention, as shown in FIGS. 1-9C, an equity tracking system 1000a analyzes, predicts, and assesses equity conditions for asset(s) in order to guide a consumer to maximizing the value and equity of his/her assets.

FIG. 1 shows a component-level diagram of some embodiments of an illustrative equity tracking system 1000a for analyzing, predicting, and assessing equity conditions for asset(s). Particularly, in this example, equity tracking system 1000a comprises a computing device 101 having a processor 310 interfaced with other hardware via bus 370. The microprocessor 310 can be provided by a general purpose microprocessor or by a specialized microprocessor (e.g., an ASIC). In some embodiments, system 1000a may include a single microprocessor which can be referred to as a central processing unit (CPU). In other embodiments, system 1000a includes two or more microprocessors, for example, a CPU providing some or most of the system functionality and a specialized microprocessor performing some specific functionality. A skilled artisan would appreciate the fact that other schemes of processing tasks distribution among two or more microprocessors are within the scope of this disclosure. A memory 320, which can comprise any suitable tangible (and non-transitory) computer-readable medium such as RAM, ROM, EEPROM, or the like, embodies program components that configure operation of the computing device. In some embodiments, the equity tracking system 1000a is purely software. The equity tracking system 1000a may be implemented on a mobile phone, tablet, computer (i.e., laptop or desktop), smart watch, and/or any other relevant device.

The memory 320 may include a plurality of program modules. Although FIG. 1 illustrates five modules 353-357, the memory 320 may include any number of modules. Modules 353, 354, 355, 356, and 357 are depicted to illustrate how a device may be configured to generate output data to a consumer. In this example, a detection module 354 configures processor 310 to monitor asset(s) based on relevant input data. For example, module 354 may sample one or more of inputs 121, 130 in order to discern, detect, analyze data related to asset(s). The system 1000a may include any number and type of inputs. In some embodiments, the input 121 is a local market data system and the input 130 is at least one data repository for a specific asset. Other potential inputs for the system 1000a include comparative sales databases, historical asset databases, financial market databases, etc. These additional inputs may provide data for calculating options used to recommend tactics, real-time calculations of depreciation, and any other appropriate information.

Determination module 355 represents a program component that analyzes data to identify/classify the asset and/or to assign strategies for maximizing equity and avoiding cost. Particularly, module 355 comprises code that determines, based on all available input data, whether the data dictates immediate action or a change in recommendations for the consumer.

Generation module 356 represents programming that causes processor 310 to generate and transmit a signal to communication interface module 340, which causes communication interface module 340 to generate the selected output. For example, generation module 356 may access stored information or commands to send to communication interface module 340. As another example, generation module 356 may receive a desired type of data and utilize signal processing algorithms to generate an appropriate signal to send to communication interface module 340 and/or to input/output (I/O) interface module 315. Some embodiments may utilize multiple output devices in concert to output the data. In some embodiments, processor 310 may stream or transmit the data to the communication interface module 340 and/or to the I/O interface module 315.

Artificial intelligence module 357 utilizes artificial intelligence to efficiently analyze, classify, and act on input data (including portions of images, sales data, financial information, and other input). The artificial intelligence module 357 combines large amounts of data with rapid processing and intelligent algorithms, allowing the system 1000a to learn automatically from patterns or features in the data. Accordingly, the artificial intelligence module 357 produces cognitive computing resulting in a natural, human-like interaction with the consumer.

The computing device 101 may include a communication interface module 340 communicatively coupled to the system bus 370. In one embodiment, the communication interface can be provided by a wireless communication interface. The wireless communication interface can be configured to support, for example, but not limited to, the following protocols: at least one protocol of the IEEE 802.11/802.15/802.16 protocol family, WIFI, Bluetooth®, at least one protocol of the HSPA/GSM/GPRS/EDGE protocol family, TDMA protocol, UMTS protocol, LTE protocol, broadband cellular network technology (including 3G, 4G, 5G, etc.), and/or at least one protocol of the CDMA/IxEV-DO protocol family. The communication interface module 340 may include one or more communication modules (e.g., modules 350, 360, etc.) to facilitate various types of communication (cellular, WIFI, Bluetooth, etc.). Although FIG. 1 shows two modules (350 and 360), the communication interface module 340 may include any number of modules. In some embodiments, module 350 is a cellular/mobile connection module and module 360 is a WIFI connection module. The communication interface module 340 may connect the system 1000a to a network 190 (i.e., the internet) and/or to one or more other systems 1000b, 1000c, 1000d, . . . 1000N. The connection to the network 190 allows the system 1000a to access data stored in cloud-based databases (or other remote databases), to access the internet to analyze input data, and/or to upload input data collected (including data from inputs 121, 130, among others). In some embodiments, a connection to other nearby similar systems (e.g., 1000b, 1000c, 1000d, . . . 1000N) allows the systems 1000 to pool and share resources (including processing and memory resources, data sharing, among others) in a mesh network to increase computational efficiency, decrease lag and delay, increase the volume and speed of data shared to centralized servers, and any other appropriate advantages.

FIG. 1 shows the input(s) 121, 130 and secondary device(s) 122 as directly connected to the system bus 370. However, in some embodiments, one or more of these modules may be connected to the I/O interface module 315 (or these object(s) may be connected to both the system bus 370 and the I/O interface module 315). In addition, FIG. 1 shows the interpretation and processing module 353 (which receives information from input(s) 121) as directly connected to both the input(s) 121 and the system bus 370 (as part of or through a connection to the memory 320). However, in some embodiments, the interpretation and processing module 353 may be connected to only one of the input(s) 121 and the system bus 370.

As shown in FIG. 1, the computing device 101 may include a Global Positioning System (GPS) module 380 and a localization module 390 for discerning location information for the system 1000a. In some embodiments, the GPS module 380 determines a geographic location of the system 1000a.

Local storage module 375 is an additional component that can replaced with upgraded or expanded modules and is attached to the system bus 370. The local storage module 375 may be a fixed storage media, a modular removable media, or any other appropriate storage device. The local storage module 375 may be compatible with, for example, auxiliary hard drives (including flash memory), SD cards, micro SD cards, RAM, communication interfaces, etc. In some embodiments, the local storage module 375 allows some data to be stored locally including specific asset data, financial data related to the consumer, local database information based on geographic location (e.g., based on GPS module 380), data learned/created by the artificial intelligence module 357, and/or any other appropriate information.

In some embodiments, the I/O interface module 315 may be used to facilitate connection to devices such as one or more displays, keyboards, mice, speakers, microphones, cameras, and/or other hardware used to input data or output data. For example, in some embodiments, the I/O interface module 315 is connected to inputs. The I/O interface module 315 may interface with at least one Universal Serial Bus (USB) port 123, at least one micro USB port 129, and any other appropriate port which can operate as either an input or an output. The I/O interface module 315 may also interface with one or more types of output including, for example, an auditory output module 317, a visual output module 318, a haptic output module 319, and/or any other appropriate output device. The auditory output module 317 may include a sound/beep, spoken words describing available data, or any other auditory output and may be delivered through a speaker, through an earpiece (wired or wireless) worn by the consumer, through an audio/video system of a vehicle, through a remote-operated computer system, or by any other appropriate manner. The visual output module 318 may include a flashing light, text describing available data, or any other visual output and may be delivered through a small screen on the device (e.g., equity tracking system 1000a), through a head-up display (HUD) device (wired or wireless) worn by the consumer, through an audio/video system of a vehicle, or by any other appropriate manner.

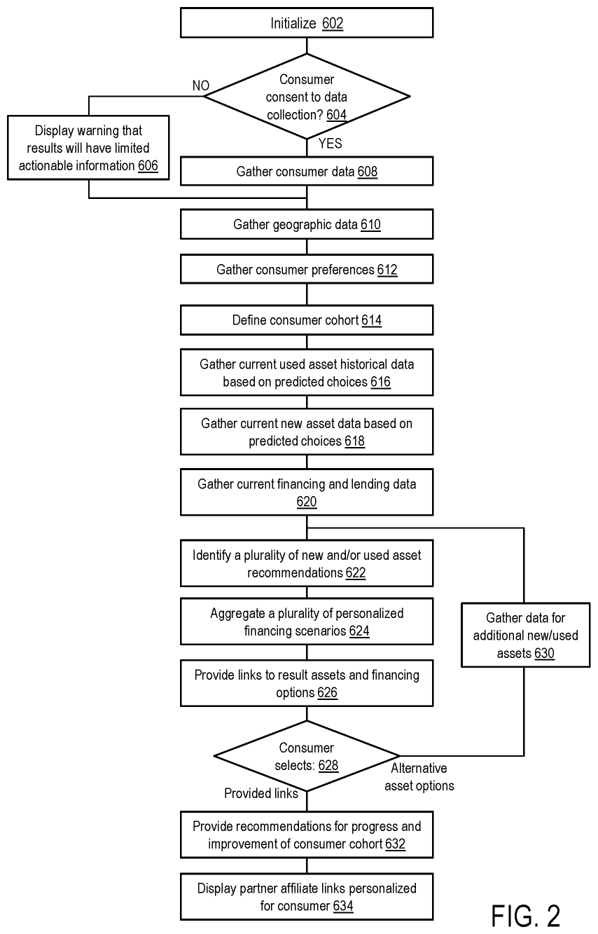

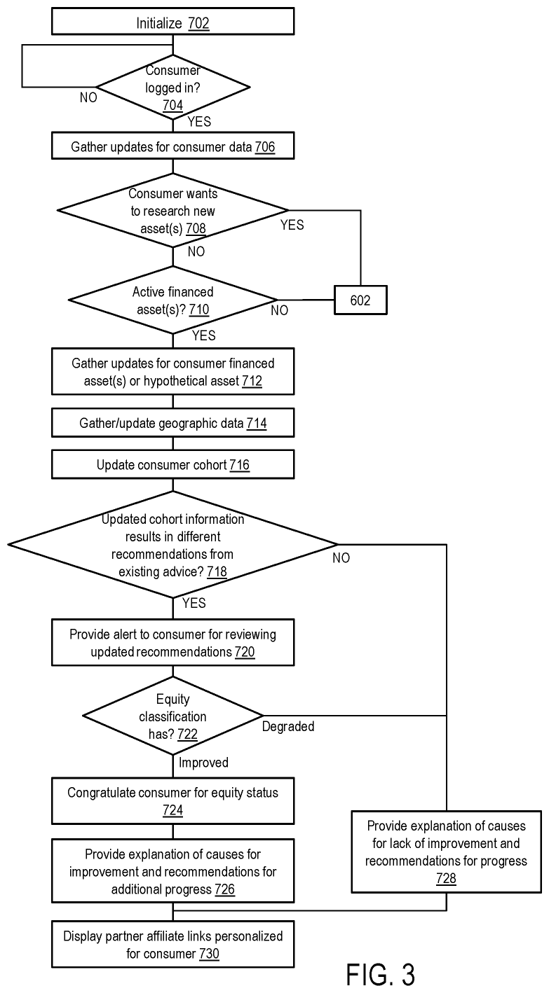

FIGS. 2 and 3 illustrate some non-limiting embodiments of flowcharts describing some steps that the system 1000a may use when operating. In some examples, the system 1000a includes some of all of the steps illustrated in FIG. 2 when the consumer has not yet created an account and/or has not yet registered a financed asset within the system 1000a. The system 1000a may ask the consumer/user to consent to sharing his/her data (see step 604). If approved, the system will then collect detailed consumer data in step 608, which may include financial data, a credit score, insurance data/records, previous asset(s) that were financed/owned, past residences, past travel patterns, past commuting patterns, and/or any other relevant data for the consumer. In some cases, the consumer is a company (corporation, LLC, partnership, etc.). The company may have similar information as described above (i.e., for a small company) or many have significantly more information. For example, the company may have locations in multiple countries, states, or cities with entire fleets of assets that can be tracked and analyzed. In some embodiments, if the consumer does not consent to data collection in step 604, the system will proceed to step 606 where the system indicates that information based on less comprehensive and personalized data will yield lower quality (less valuable) results with less actionable information. For example, without personalized financial data for the consumer, the system 1000a cannot adequately select assets in the consumer's price range or provide financing options optimized for the consumer's financial situation. In examples where the asset in car or truck, the consumer may attempt to search for cars that are too expensive and not within his/her budget or may unnecessarily spend time applying for financing with unfavorable terms.

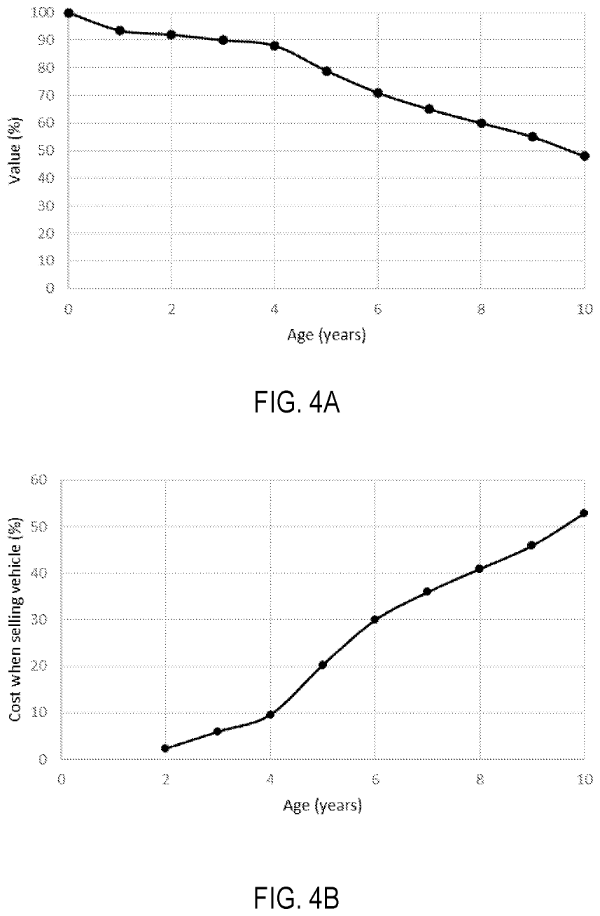

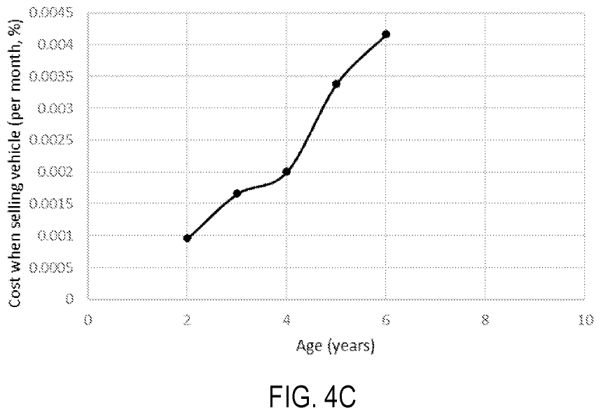

In step 610, the system 1000a gathers geographic data. This data supplements any consumer data already collected. The geographic data may include local market conditions, weather patterns, population and demographic data, and/or any other relevant data. For example, when the asset is a new car/truck, the market condition data may include new local sales prices, used local sales prices, local inventory and related trends for new and used vehicles, local market effects on depreciation, etc. The system 1000a may be capable of evaluating sales volumes and popularity of local dealerships (new and used) through tax records, registration records, inventory changes, employment records, visual information via traffic camera, social media data, etc. In addition, the system 1000a may evaluate local results and outcomes related to local private party sales through evaluation of multiple online retailers, social media classified information, local state/municipal tax and registration records, etc. In some embodiments, the weather pattern data may be combined with local municipality/city/county/state data for analysis. For example, in a region that has significant annual snowfall, if the local authorities use corrosive materials for deicing (e.g., salt and/or other chemicals), the system 1000a may adjust depreciation data and predictions accordingly. For businesses with multiple vehicles and/or multiple locations, this step may include reviewing information for multiple locations. In some embodiments, the system 1000a also uses the geographic data from step 610 to modify/adjust data such as the information shown in FIGS. 4A-9C. For example, for two similar vehicles where vehicle A has exclusively been located in a dry climate (e.g., Arizona) and vehicle B has exclusively been located in a climate with snow where salt and/or other chemicals are applied to roads (e.g., Massachusetts), the system will show accelerated depreciation for vehicle B compared to vehicle A. In addition, geographic and associated demographic data from step 610 can be used to assess the value of features and option packages of various assets. Optional sunroofs and convertibles may have less value in rainy and/or cold climates. Off-road features and option packages may be assigned higher value in areas where overlanding and off-highway driving are more prevalent/popular. Vehicles with all wheel drive may be assigned lower depreciation in areas where icy road conditions are common. Electric cars may be assigned lower values (or higher depreciation) in rural areas with few charging stations. Small vehicles may be assigned higher values in heavily urban areas where parking is limited.

In some embodiments, the system 1000a determines location (see step 610) using GPS module 380, cellular data (module 350), WIFI information (module 360), and/or any other appropriate system. Based on the location information, the system 1000a may access a particular set or subset of databases. For example, if the system 1000a detects a different town, city, county, state, or country, the system 1000a may access more/different databases. In some embodiments, the system 1000a may have information stored in database(s) that is used to evaluate asset(s) and financial data. The data may include depreciation projections, recent sales information for similar assets (retail and/or private party), information tracking frequency and quantity of searches for similar assets by prospective consumers, and/or other appropriate data to aid in analysis. The database(s) may include data for vehicle dealerships, social media data, private party sales, insurance registration/filings, tax records, registration records, or other relevant objects. The system 1000a may connect to at least one database (see step 610), which may include a connection to one or more external database(s) including a remote server, a cloud-based server, or any other remote source. In some cases, the system 1000a may also have local storage (local hard disk, solid state drive, etc.) for storing relevant data. The system 1000a may also be able to detect real-time changes and updates to the database, which may be local for a municipality, city, state, or federal level.

The system 1000a may elicit input from the consumer in step 612. For example, the consumer can provide one or more different searches for types of assets. In an example of a consumer looking for an automobile, the consumer may select desired characteristics including, for example, a preference between internal combustion engines and electric power (which may include further specificity related to fuel type, hybrid configurations, etc.), number of seats, available luxury features, cargo capacity, intended usage, payload capacity, price, among numerous other characteristics. In some embodiments, the consumer may create multiple different searches that the system 1000a monitors. For example, the consumer may have a first search for an inexpensive commuter car, a second search for a pickup truck able to carry/tow large loads, a third search for a comfortable luxurious long distance vehicle, a fourth search for a capable off-road sport utility vehicle, a fifth search for a sports car capable of racing during track days, a sixth search for a sailboat capable of traveling hundreds of miles off shore, a seventh search for a recreational vehicle for supporting a family of four or more people for multiple weeks, and/or any other relevant types of search. For businesses with multiple vehicles and/or multiple locations, this step may include fleet information and target budget information.

In step 614, the system 1000a analyzes data from one or more of the previous steps to define a cohort for the consumer. In some cases, the system 1000a uses data from at least one of steps 608, 610, 612 to define the cohort. The system 1000a may include data from other sources also. In some embodiments, the system 1000a classifies the consumer into a category based on various factors. The system 1000a may include any number of categories or subcategories including as few as two or as many 1,000. In some embodiments, the system 1000a initially places the consumer into one of three main categories of “Equity Enabled,” “Equity Neutral,” and “Equity Depleted.” In some embodiments, each of the aforementioned categories includes a plurality of subcategories based on the known consumer data, geographic data, and/or consumer preferences. The Equity Enabled category may be related to the status of currently financed asset(s) associated with the consumer and/or the consumer's standing for a potential future acquisition. For example, the system 1000a may determine that the consumer has positive equity in one or more currently financed assets (i.e., that selling the asset and paying off any relevant loan would result in positive cash flow). The system may also analyze and determine that the consumer's financial situation would allow for a more than adequate down payment and/or a sufficient trade-in asset for a potential future purchase. In some cases, the system 1000a may classify the consumer into one of a plurality of subcategories within the Equity Enabled category.

The Equity Neutral category may be related to the status of currently financed asset(s) associated with the consumer and/or the consumer's standing for a potential future acquisition. For example, the system 1000a may determine that the consumer has neutral equity in one or more currently financed assets (i.e., that selling the asset and paying off any relevant loan would result in a zero net cash flow). The system may also analyze and determine that the consumer's financial situation would allow for an adequate down payment and/or a non-zero value trade-in asset for a potential future purchase. In some cases, the system 1000a may classify the consumer into one of a plurality of subcategories within the Equity Neutral category.

The Equity Depleted category may be related to the status of currently financed asset(s) associated with the consumer and/or the consumer's standing for a potential future acquisition. For example, the system 1000a may determine that the consumer has depleted equity in one or more currently financed assets (i.e., that selling the asset and paying off any relevant loan would result in a negative net cash flow). The system may also analyze and determine that the consumer's financial situation would allow for an inadequate down payment and/or a negative value trade-in asset for a potential future purchase. In some cases, the system 1000a may classify the consumer into one of a plurality of subcategories within the Equity Depleted category.

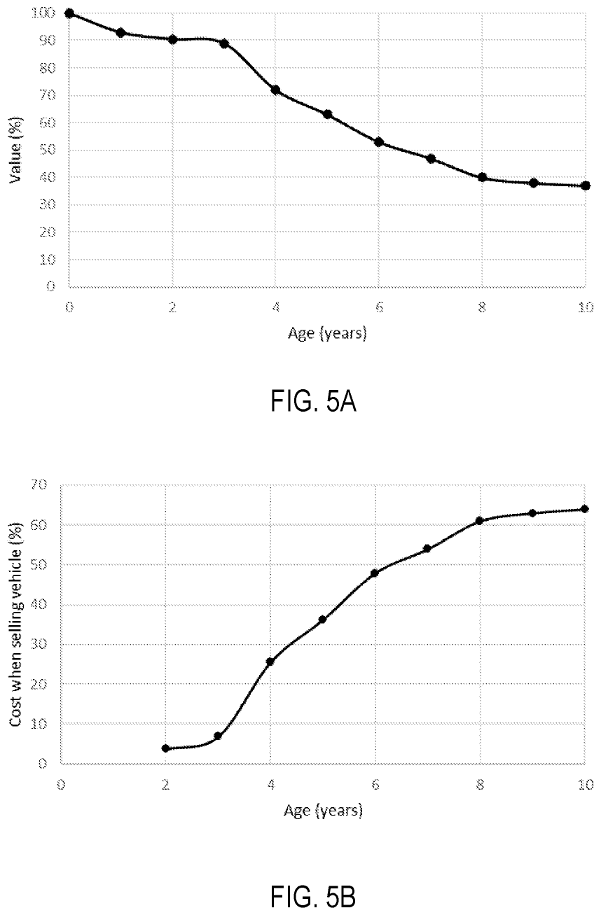

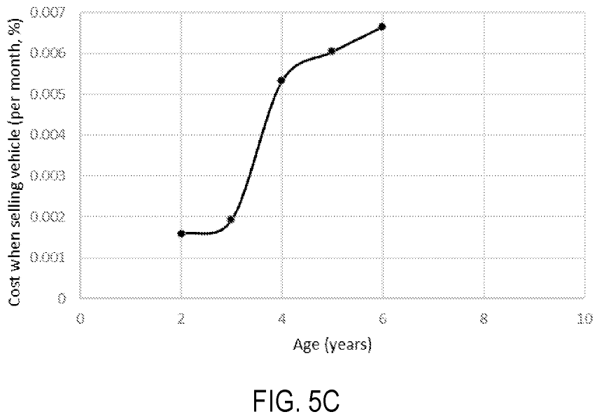

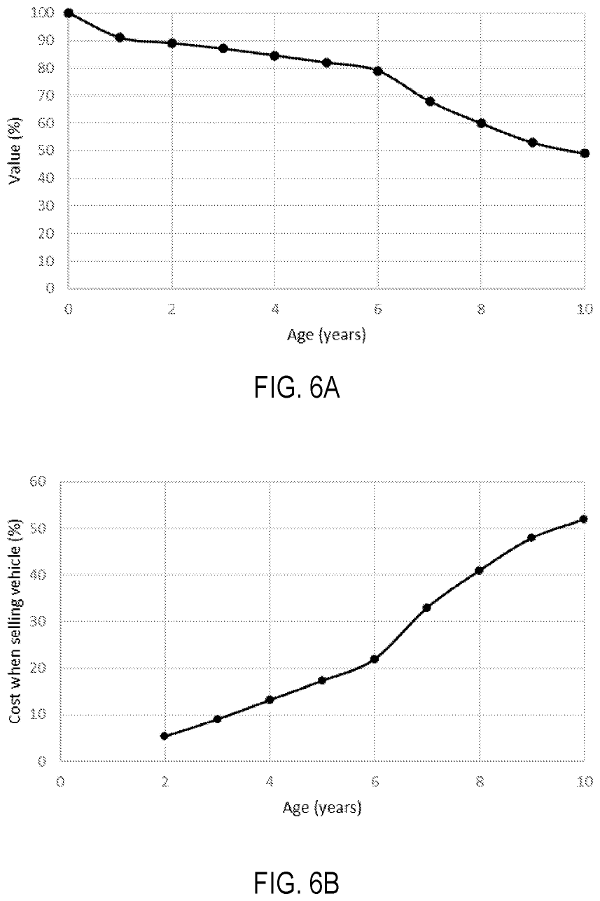

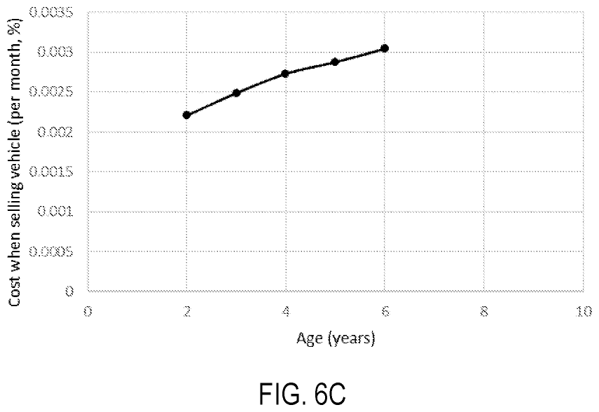

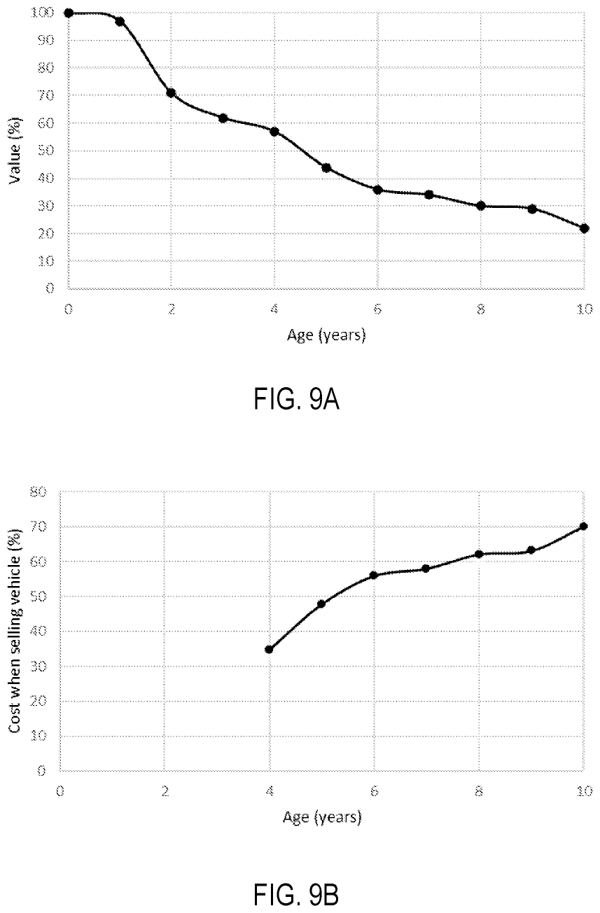

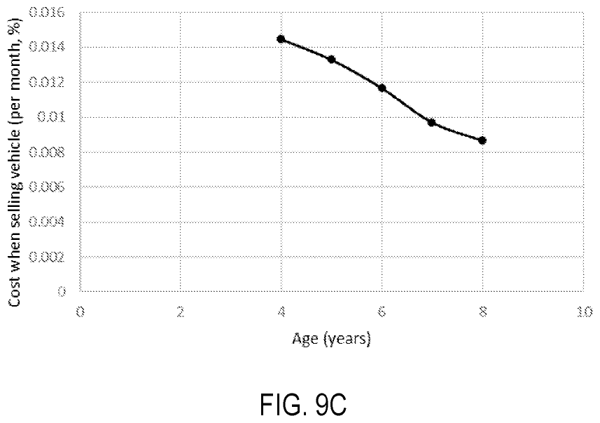

After classifying the consumer into a cohort in step 614, the system 1000a proceeds to steps 616 and 618. These steps include analysis of the consumer's financial situation, asset preferences, cohort, local geographic data (as described above), and/or other factors such that the system 1000a predicts a group of likely choices for the consumer. Step 616 focuses on pre-owned assets and step 618 focuses on new assets. In the example of automobiles, the system 1000a may analyze thousands of vehicle options and select a plurality of both new and used vehicle choices for the consumer. Part of such an analysis may include known and predicted depreciation for the vehicles and predicted costs when selling such vehicles in the future. FIGS. 4A-9C show some examples of data that can analyzed by the system. For example, some luxury vehicles include significant decreases in value such that a purchase of an approximately 2-year old vehicle may be advisable (see FIG. 9A). Other vehicles may be more suited to purchase when they reach 4-years old (see FIG. 5A). Some vehicles retain value such that it may be advisable to buy when they are new (see FIGS. 4A and 6A).

The illustrative data shown in FIGS. 4A-9C is based on extensive data analysis including historical depreciation data combined with recent sales information. The data is further combined with data unavailable to consumers doing their own individual research. This further data may include information gleaned from local dealerships by evaluating sales volumes and popularity of the dealerships (new and used) through tax records, registration records, inventory changes, employment records, visual information via traffic camera, social media data, etc. Further, the data is augmented and adjusted using location data algorithms that cannot be replicated by humans through combination of constantly changing and predictive factors. Additional information related to future supply chain concerns for certain vehicles may also be factored into the analysis. For example, for certain electric vehicles, the future available of batteries or other power sources will be considered in an analysis of future depreciation and value of the vehicle.

In some embodiments, in step 620, the system 1000a communicates with financial institutions and lenders to acquire options and terms for the consumer based on the data collected in one or more of steps 608-618. Based on pre-arranged relationships with various financial institutions, the system 1000a efficiently acquires a plurality of accurate predictions for available loan terms for the consumer from multiple sources. Similar results would not be possible for a consumer to replicate without significantly more time and interaction with each individual potential lender.

When the system 1000a reaches step 622-626, the consumer receives specific options/recommendations for assets (step 622) and options/recommendations for financing/loans (step 624) along with supporting information and links to these options (step 626). The system 1000a may use artificial intelligence module 357 to negotiate with multiple dealerships to for similar vehicles or based on volume purchasing (i.e., for businesses with fleets). The links may send the consumer to a website of a new car dealership, a used car dealership, a manufacturer (where the consumer can order a vehicle), an online listing for a private party vehicle, a social media listing for a vehicle, a bank lending department, a credit union lending department, an online lender's site, and/or any other relevant place. In some embodiments, step 626 includes one or more documents (either in lieu of or in addition to) the links. For example, the system 1000a may provide a master document with all of the assets and financing options listed. In some cases, the system 1000a provides a separate document for each asset and each financing option where detailed information is provided in the document. For example, the document (master document or separate document) may provide a detailed history of a used vehicle (ownership history, maintenance records, accident history, etc.). Such a document may also provide particular information relevant to the consumer and the vender. For example, the document may provide a promotional code that communicates to the dealership information about the consumer and expedites the process of test driving and/or purchasing the vehicle from the dealership. In some embodiments, the document and/or the promotional code provides a discounted price (and/or other advantages such as an extended warranty) from the dealership that is negotiated through the system 1000a before the consumer discusses the vehicle with the dealership.

The options/recommendations for financing/loans created in step 624 and provided to the consumer in step 626 may include multiple lending options from multiple lenders. Similar to the asset data described above, step 626 may include a document (master document or separate document for each option) that provides detailed information and terms for each lending option (APR, term, payment options, etc.). Such a document may also provide particular information relevant to the consumer and the lender. For example, the document may provide a promotional code that communicates to the lender information about the consumer and expedites the process of applying for and being approved for the loan from the lender. In some embodiments, the document and/or the promotional code provides advantageous terms from the lender that are negotiated through the system 1000a before the consumer discusses the loan with the lender.

In some embodiments, steps 616 through 626 are known as the vehicle equity management tool. In some embodiments, the artificial intelligence module 357 allows the system 1000a to proceed through these steps more efficiently by eliminating undesirable options and search results. In some embodiments, steps 608 through 614 are known as the vehicle equity educator.

In step 628 the system 1000a determines whether the consumer is satisfied with the results produced in steps 622-626. If the consumer asks for alternative options (i.e., is not satisfied), the system 1000a moves to step 630 and gathers additional information about other new and used assets before returning to step 622. If the consumer accepts the provided information at step 628 (i.e., is satisfied), the system 1000a moves to step 632 where the system provides a summary of the consumer cohort information along with recommendations for the consumer to improve his/her cohort (to improve financial wellbeing). The system 1000a then moves to step 634 where partner affiliate links/information are provided to the consumer. In some examples, the partner affiliate links/information include insurance providers, companies that specialize in parts/accessories for the selected asset, companies that provide repairs and/or services related to the asset, certified financial planners, and/or any other relevant information. In some embodiments, the insurance carrier information may be analyzed through the system 1000a at steps 622-624. The consumer may have the option of answering a yes/no question about the system 1000a should analyze and provide insurance carrier information.

In some embodiments, when a consumer has an account and/or has already registered financed asset(s) with system 1000a, there is a different process. An illustrative example is shown in FIG. 3. The system 1000a may check to confirm that the consumer is logged into an account in step 704. Although not required for all embodiments, for security purposes, the system 1000a may check for biometric input before continuing operation of the system 1000a. The biometric input may be facial recognition, a fingerprint, an optical scan, retinal scan, voice recognition, a biochemical sensor, an electrocardiogram (ECG/EKG) sensor, gait recognition, and/or any appropriate sensor. The system 1000a may be inoperable without a specific biometric input. The system 1000a may be linked to and to allow access based on the biometric data of an individual user or a list of users (i.e., a list of authorized representatives for a company) and/or may be capable of preventing operation otherwise.

When reaching step 706 (assuming authorization has been provided, similar to step 604), the system 1000a will update consumer data. For example, in some cases, the system 1000a previously collected user data (see step 608) but to provide the most advantageous recommendations, the system 1000a will acquire updated data in step 706. This data may include, for example, information leading to changes in the consumer's credit score and/or insurance data/records.

The system 1000a may ask whether the consumer wants to research a new assert purchase in step 708. If the consumer answers yes, the system 1000a proceeds to step 602 (see FIG. 2). If the consumer answers no, the system 1000a proceeds to step 710.

In step 710, the system 1000a determines whether the consumer has an active loan or other financial arrangement being tracked by the system 1000a. If not, system 1000a proceeds to step 602 (see FIG. 2) because there is an assumption that the consumer is interested in reviewing potential asset purchases. However, in some cases, the consumer may have the option to proceed to step 712 using a hypothetical asset. For example, the consumer may want to evaluate their financial status (consumer cohort) and review strategies for improving. If active loan(s) or other financial arrangement(s) are found, the system 1000a proceeds to step 712 where data related to the financed asset(s) is updated. For example, the system 1000a will determine how many payments have been made, how much principal remains outstanding, how much equity the consumer has in the asset, how the value of the asset has changed, and any other relevant data.

In step 714, the system 1000a gathers/updates geographic data. For example, in some cases, the system 1000a previously collected geographic data (see step 610) but to provide the most advantageous recommendations, the system 1000a will acquire updated data in step 714.

The system 1000a may update and/or reevaluate the consumer cohort in step 716. For example, system 1000a may begin with data from step 614 (and/or a previous iteration of step 716). In some cases, the system 1000a uses data from at least one of steps 706, 712, 714 to define/update the cohort. The system 1000a may include data from other sources also.

In step 718, the system 1000a compares updated cohort information from step 716 to the previous cohort information (typically from a previous iteration of step 716 or from step 614). If the cohort has not changed sufficiently such that the message provided in step 632 does not need to be updated, the system 1000a proceeds to step 728. In step 728 the system 1000a provides information describing the lack of progress and recommendations for improving the cohort (in some cases reiterating the message from step 632).

If the cohort information does result in different advice at step 718, the system moves to step 720 where an alert is provided to the consumer that there are new recommendations. At step 722 the system determines whether the equity status of the consumer has improved or degraded. If the equity status of the consumer has degraded, the system 1000a moves to step 728 where the system 1000a provides information describing the lack of progress and recommendations for improving the cohort. In some embodiments, the information provided at step 728 is different when the equity status has degraded compared to when the equity status is unchanged (i.e., when the system reaches step 728 directly from step 718).

If the system 1000a determines that the equity status of the consumer has improved at step 722, the system 1000a moves to step 724 where a message is provided to the consumer to congratulate the consumer for improvement of the equity status or cohort. The system 1000a may then move to step 726 where explanation is provided to show how and why the consumer's cohort improved along with recommendations for the consumer to further improve his/her cohort (to improve financial wellbeing). In some embodiments, the information provided in step 726 may be similar to that provided in step 632. However, the information provided in step 726 is informed by concrete and tangible improvement that has already taken place. After either step 726 or step 728, the system 1000a moves to step 730 where partner affiliate links/information are provided to the consumer. In some examples, the partner affiliate links/information include insurance providers, companies that specialize in parts/accessories for the selected asset, companies that provide repairs and/or services related to the asset, certified financial planners, and/or any other relevant information.

As the consumer follows the guidance provided by the system 1000a, the consumer increases equity of his/her asset(s) and avoids large losses due to depreciation. These actions result in monetary savings, improved credit scores, the ability to afford nicer different assets in subsequent purchases, and/or various other benefits. For businesses with fleets of the vehicles, in addition to the aforementioned effects, the system 1000a can lead to increased cash flow and reduced costs for fleet operation.

Although the system 1000a is designed to maximize equity in the asset(s) for the consumer, there may be situations where the consumer has negative equity (i.e., owes more to the lending than the asset is worth). See Equity Depleted category, as described above. These situations may arise when the consumer begins using the system 1000a after acquiring the asset(s) (e.g., consumer purchases an asset during or immediately prior to a high depreciation rate period), when the consumer disregards the recommendations from the system 1000a, through unforeseen circumstances such as an automobile accident where the insurance company refuse to pay a sufficient amount and the asset is significantly reduced in value due to the accident, or other relevant situations. When evaluating a negative equity situation (see FIG. 3), the system 1000a will provide tangible advice for improving the equity status. The advice may include paying down loan(s) faster (i.e., pay extra toward the principal each month) to increase equity in the asset, selling the asset and purchasing a lower cost asset which allows an easier path to a positive equity position, and/or other relevant advice.

In some embodiments, to ensure maximum equity value in the asset(s), the system 1000a provides reminders to the consumer maintenance and upkeep of the asset.

FIGS. 4A-4C show some exemplary data that system 1000a analyzes for a first vehicle. In some embodiments, the first vehicle is a family sedan. FIG. 4A is a predicted depreciation curve for the first vehicle at a snapshot in time. As described above, the system 1000a continuously updates data such that FIGS. 4A-4C would change (constantly or nearly constantly). In some embodiments, this data would update during one or more of the following steps: steps 610, 616, 618, 622, 630, 706, 712, and/or 714. FIG. 4B illustrates analysis or projection for the cost of owning the asset where the system is projecting a new vehicle purchase (year 0) with a 6 year (72 month) loan at approximately 1% APR with a 10% down payment where the consumer keeps the asset for at least 2 years. In some embodiments, the system 1000a will advise the consumer that selling the asset after 4 years of ownership will maximize the equity such that the net cost of owning the asset after selling at year 4 will be approximately 10% of the asset cost. FIG. 4C shows the amortized monthly cost over the life of the loan where there is a substantial increase between year 4 and 5. The data shown in FIGS. 4A-4C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

FIGS. 5A-5C show some exemplary data that system 1000a analyzes for a second vehicle. In some embodiments, the second vehicle is a sedan. FIG. 5A is a predicted depreciation curve for the second vehicle at a snapshot in time. As described above, the system 1000a continuously updates data such that FIGS. 5A-5C would change (constantly or nearly constantly). In some embodiments, this data would update during one or more of the following steps: steps 610, 616, 618, 622, 630, 706, 712, and/or 714. FIG. 5B illustrates analysis or projection for the cost of owning the asset where the system is projecting a new vehicle purchase (year 0) with a 6 year (72 month) loan at approximately 1% APR with a 10% down payment where the consumer keeps the asset for at least 2 years. In some embodiments, the system 1000a will advise the consumer that selling the asset after 3 years of ownership will maximize the equity such that the net cost of owning the asset after selling at year 3 will be approximately 7% of the asset cost. FIG. 5C shows the amortized monthly cost over the life of the loan where there is a substantial increase between year 3 and 4. The data shown in FIGS. 5A-5C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

FIGS. 6A-6C show some exemplary data that system 1000a analyzes for a third vehicle. In some embodiments, the third vehicle is a small hybrid sedan. FIG. 6A is a predicted depreciation curve for the third vehicle at a snapshot in time. As described above, the system 1000a continuously updates data such that FIGS. 6A-6C would change (constantly or nearly constantly). In some embodiments, this data would update during one or more of the following steps: steps 610, 616, 618, 622, 630, 706, 712, and/or 714. FIG. 6B illustrates analysis or projection for the cost of owning the asset where the system is projecting a new vehicle purchase (year 0) with a 6 year (72 month) loan at approximately 1% APR with a 10% down payment where the consumer keeps the asset for at least 2 years. In some embodiments, the system 1000a will advise the consumer that selling the asset after 6 years of ownership will maximize the equity such that the net cost of owning the asset after selling at year 6 will be approximately 22% of the asset cost. In some cases, the increase in depreciation rate after year 6 reflects the increasing likelihood of battery replacement (a significant maintenance cost). Part of the constant updates described above including ongoing analysis of battery technology such that the system 1000a will update the data in FIGS. 6A-6C based on technological and supply chain changes that reduce or increase battery availability and cost. FIG. 6C shows the amortized monthly cost over the life of the loan. The data shown in FIGS. 6A-6C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

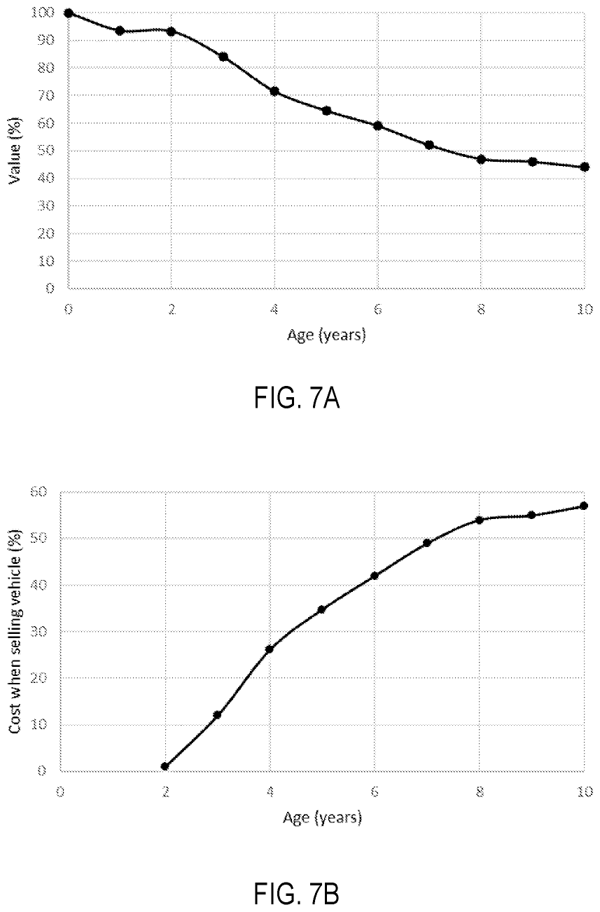

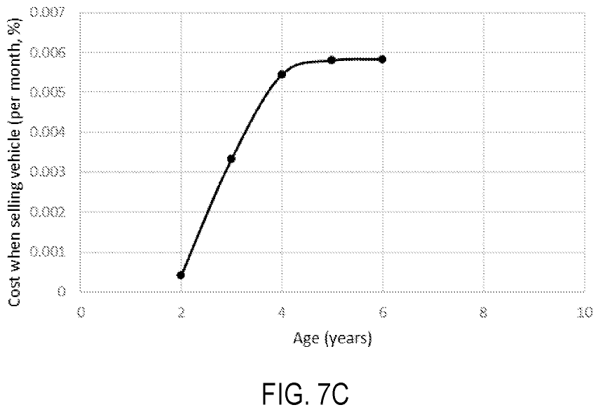

FIGS. 7A-7C show some exemplary data that system 1000a analyzes for a fourth vehicle. In some embodiments, the fourth vehicle is an electric sedan. FIG. 7A is a predicted depreciation curve for the fourth vehicle at a snapshot in time. As described above, the system 1000a continuously updates data such that FIGS. 7A-7C would change (constantly or nearly constantly). In some embodiments, this data would update during one or more of the following steps: steps 610, 616, 618, 622, 630, 706, 712, and/or 714. FIG. 7B illustrates analysis or projection for the cost of owning the asset where the system is projecting a new vehicle purchase (year 0) with a 6 year (72 month) loan at approximately 1% APR with a 10% down payment where the consumer keeps the asset for at least 2 years. In some embodiments, the system 1000a will advise the consumer that selling the asset after 2 years of ownership will maximize the equity such that the net cost of owning the asset after selling at year 2 will be approximately 1% of the asset cost. In some cases, the low cost in the early years of the loan term reflects the popularity and high demand for the asset. FIG. 7C shows the amortized monthly cost over the life of the loan where there is a substantial increase between year 2 and 3. The data shown in FIGS. 7A-7C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

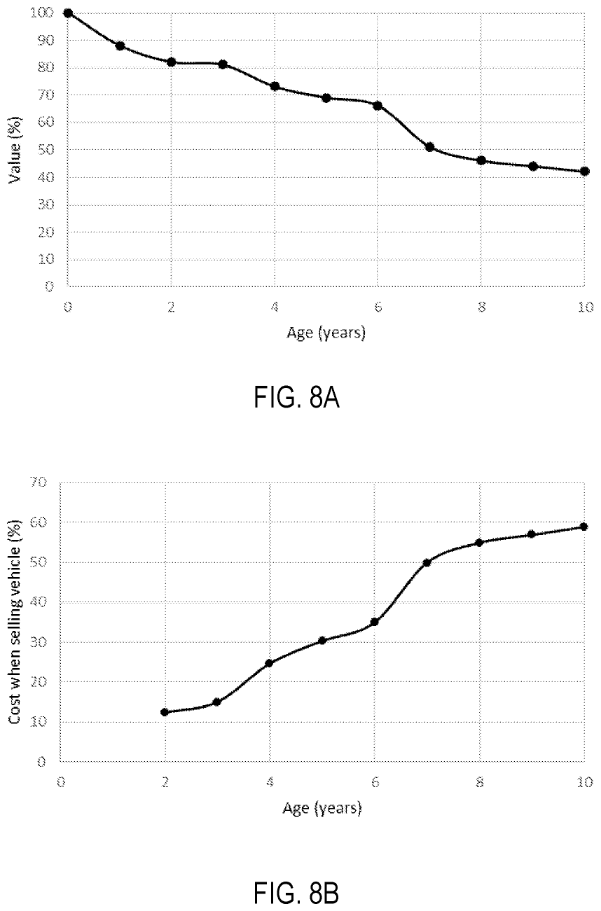

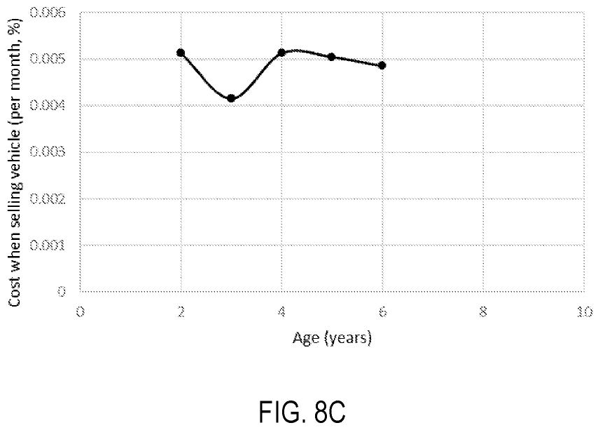

FIGS. 8A-8C show some exemplary data that system 1000a analyzes for a fifth vehicle. In some embodiments, the fifth vehicle is a luxury sport utility vehicle. FIG. 8A is a predicted depreciation curve for the fifth vehicle at a snapshot in time. As described above, the system 1000a continuously updates data such that FIGS. 8A-8C would change (constantly or nearly constantly). In some embodiments, this data would update during one or more of the following steps: steps 610, 616, 618, 622, 630, 706, 712, and/or 714. FIG. 8B illustrates analysis or projection for the cost of owning the asset where the system is projecting a new vehicle purchase (year 0) with a 6 year (72 month) loan at approximately 1% APR with a 10% down payment where the consumer keeps the asset for at least 2 years. In some embodiments, the system 1000a will advise the consumer that selling the asset after either 3 years or 6 years of ownership will maximize the equity such that the net cost of owning the asset after selling at year 3 will be approximately 15% of the asset cost or after selling at year 6 will be approximately 35% of the asset cost. FIG. 8C shows the amortized monthly cost over the life of the loan where there is a substantial increase between year 3 and 4. The data shown in FIGS. 8A-8C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

FIGS. 9A-9C show some exemplary data that system 1000a analyzes for a sixth vehicle. In some embodiments, the sixth vehicle is another luxury sport utility vehicle. FIG. 9A is a predicted depreciation curve for the sixth vehicle at a snapshot in time. As described above, the system 1000a continuously updates data such that FIGS. 9A-9C would change (constantly or nearly constantly). In some embodiments, this data would update during one or more of the following steps: steps 610, 616, 618, 622, 630, 706, 712, and/or 714. FIG. 9B illustrates analysis or projection for the cost of owning the asset where the system is projecting a used vehicle purchase at 2 years old with a 6 year (72 month) loan at approximately 1% APR with a 10% down payment where the consumer keeps the asset for at least 2 years. In some embodiments, the system 1000a will advise the consumer that selling the asset after 2 years of ownership (asset age of 4 years) will maximize the equity such that the net cost of owning the asset after selling at year 4 will be approximately 35% of the asset cost. FIG. 9C shows the amortized monthly cost over the life of the loan. The data shown in FIGS. 9A-9C may be used when analyzing potential purchases (see FIG. 2) and/or may be used after purchasing an asset to maximize value for the consumer (see FIG. 3). In some embodiments, maximizing value includes reducing cost and/or avoiding losses. Maximizing value may include advising the consumer to: sell asset(s) before expected significant depreciation; buy the asset(s) used and not new to avoid an initial high level of depreciation; pay down loan(s) faster (i.e., pay extra toward the principal each month); keep an asset longer because the depreciation rate is relatively flat; and/or other relevant advice.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A method of assessing and tracking equity in an asset for a consumer, the method comprising:
gathering data for the consumer;
gathering data for the asset;
gathering geographic data;
defining a consumer cohort;
analyzing consumer, asset, and geographic data; and
outputting recommendations for improving the consumer cohort.

2. The method of claim 1, wherein defining a consumer cohort comprises determining an equity status based on the data.

3. The method of claim 2, wherein the equity status comprises at least one category selected from the group of equity enabled, equity neutral, and equity depleted.

4. The method of claim 1, wherein gathering geographic data comprises local market conditions, weather patterns, population and demographic data, new local sales prices, used local sales prices, and local inventory.

5. The method of claim 1, wherein gathering geographic data comprises accessing at least one remote database specific for the geographic region of the consumer.

6. The method of claim 1, wherein the asset comprises an automobile.

7. The method of claim 1, wherein outputting recommendations for improving consumer cohort comprises at least one selected from the group of (i) paying down a loan faster and (ii) selling the asset and purchasing a lower cost asset to allow an easier path to a positive equity position.

8. The method of claim 1, wherein analyzing consumer, asset, and geographic data comprises adjusting depreciation predictions for the asset based on geographic data.

9. A system for assessing and tracking equity in an asset for a consumer, the system comprising:
a processor and a non-transitory computer-readable medium coupled to the processor, the non-transitory computer-readable medium comprising instructions that, when executed by the processor, cause the processor to:
detect a physical location of the system;
establish a connection to at least one database;
gather data for the consumer;
gather data for the asset;
defining a consumer cohort;
output a plurality of recommendations for improving the consumer cohort.

10. The system of claim 9, wherein defining a consumer cohort comprises determining an equity status based on the data.

11. The system of claim 10, wherein the equity status comprises at least one category selected from the group of equity enabled, equity neutral, and equity depleted.

12. The system of claim 9, further comprising gathering geographic data comprising local market conditions, weather patterns, population and demographic data, new local sales prices, used local sales prices, and local inventory.

13. The system of claim 9, further comprising gathering geographic data comprising accessing at least one remote database specific for a geographic region of the consumer.

14. The system of claim 9, wherein the asset comprises an automobile.

15. The system of claim 9, wherein outputting recommendations for improving consumer cohort comprises at least one selected from the group of (i) paying down a loan faster and (ii) selling the asset and purchasing a lower cost asset to allow an easier path to a positive equity position.

16. The system of claim 9, wherein analyzing consumer, asset, and geographic data comprises adjusting depreciation predictions for the asset based on geographic data.

17. The system of claim 9, further comprising determining whether the consumer has at least one financed asset that has already been evaluated.

18. The system of claim 17, further comprising providing recommendations for progress and improving the cohort.

19. The system of claim 17, further comprising determining whether updated cohort information results in different recommendations for the at least one financed asset.

20. The system of claim 19, further comprising determining whether an equity classification has improved or degraded.
